(19) United States
(12) Patent Application Publication
(10) Pub. No.: US 2021/0112970 A1
(43) Pub. Date: Apr. 22, 2021

(54) TELESCOPIC LINEAR ACTUATOR AND HEIGHT ADJUSTABLE TABLE

(71) Applicant: LOGICDATA Electronic & Software Entwicklungs GmbH, Deutschlandsberg (AT)

(72) Inventors: Philipp POLZ, Deutschlandsberg (AT); Daniel KOLLREIDER, Graz (AT); Stefan LUKAS, Preding (AT)

(21) Appl. No.: 16/766,659

(22) PCT Filed: Nov. 27, 2018
(86) PCT No.: PCT/EP2018/082707

§ 371 Date: Dec. 14, 2020

(30) Foreign Application Priority Data
Nov. 27, 2017 (DE) 10 2017 127 937.7

(51) Int. Cl. A47B 9/20; F16H 25/20

(52) U.S. Cl. CPC A47B 9/20; F16H 25/2056; F16H 2025/2087; A47B 2200/0056; F16H 2025/2075; F16H 25/2015

(57) ABSTRACT

A telescopic linear actuator (2), in particular for a table system, comprises a linear drive (11) which is arranged to move the linear actuator (2) over a total lift (GH), wherein the total lift (GH) is composed of a primary lift (HH) and a secondary lift (NH), and the linear actuator (2) is arranged to move the primary lift (HH) and the secondary lift (NH) sequentially.

### FIELD OF THE INVENTION

The present disclosure relates to a telescopic linear actuator, in particular for a table system, comprising a linear drive adapted to move the linear actuator over a total lift. The disclosure further relates to a height-adjustable table with such a linear actuator.

### BACKGROUND OF THE INVENTION

Height-adjustable tables are often designed to serve a wide range of different body sizes. An attempt is made to ensure that the height of a table top is adjustable over an entire range for very small people in a sitting position to very large people in a standing position. These tables require telescopic linear actuators, which are, for example, installed between the table top and a foot element of the table.

However, the individual user of a height-adjustable table never needs the entire adjustable range.

The present disclosure describes a linear actuator, which makes it possible to adjust a height of a table in a primary range from a sitting to a standing height and vice versa and to make a selection, depending on a height of a user, for a suitable lift range of the primary range in a secondary range.

According to one embodiment, a telescopic linear actuator, in particular for a table system, comprises a linear drive which is designed to move the linear actuator over a total lift. The total lift is composed of a primary lift and a secondary lift and the linear actuator is arranged to move the primary lift and the secondary lift sequentially.

The sequential moving makes it possible to set the primary lift with the linear actuator independently of the secondary lift. In this way, a user of a table can change from a sitting to a standing position by extending the primary lift of the linear actuator. In this way, the height of the table can be adjusted from an individual sitting height of the user to an individual standing height of the user. The individual sitting or standing height for a user is fine-tuned by adjusting the secondary lift. However, this fine-tuning is usually carried out only once or rarely by the user. In this way, a lift range suitable for the user, which can be selected by moving the secondary lift, is selected for the primary lift. The primary lift is not changed in this process.

According to at least one embodiment, the primary lift and the secondary lift have clearly different lifting heights. For example, the maximum lifting height of the secondary lift is at most two thirds of the maximum lifting height of the primary lift. An advantageous arrangement of the lifting heights of primary and secondary lift is for example a lifting height of the primary lift of 500 millimetres and a lifting height of the secondary lift of 162 millimetres. The lifting height of the total lift is then 662 millimetres. In this way, the secondary lift can be used to set a selection, depending on the height of the user, of the lifting range which is to be moved with the primary lift. For example, a lifting height of 500 millimetres is used for the primary lift, which is usually sufficient for a height difference between a sitting position and a standing position, even for people of different heights. In this case, the secondary lift is 250 millimetres at the most, which is generally sufficient for selecting the individual lifting range for people of different heights.

According to at least one embodiment, the telescopic linear actuator has a first movement mechanism and a second movement mechanism. When the primary lift is moved, the linear drive moves the first movement mechanism, when the secondary lift is moved, the linear drive moves the second movement mechanism.

Since the linear actuator can move both the primary lift and the secondary lift with only one linear drive, both a material-friendly and cost-effective production, as well as a space-saving arrangement of the telescopic linear actuator is possible.

According to at least one embodiment, the first movement mechanism has a first thread connection and the second movement mechanism has a second thread connection, the first thread connection having a higher efficiency factor than the second thread connection.

The first and second thread connection each consists of an internal thread and an external thread that engage. Such a thread connection consists, for example, of a spindle with an external thread, which is rotatably mounted in a spindle nut, or of two tubes, an external tube with an internal thread, in which an internal tube with an external thread engages. In this way, the mechanical design of the linear actuator ensures that during a moving of the primary lift, the secondary lift stands still and the secondary lift can only be moved when the primary lift has reached a detent position. In this case the thread connection of the primary lift has the higher efficiency factor.

According to at least one embodiment, the linear drive comprises a motor and a threaded spindle driven by the motor. The linear actuator comprises a spindle nut. The threaded spindle has two stops spaced apart along a central axis of the threaded spindle. The threaded spindle is rotatably mounted in the spindle nut. The linear drive is designed to move the threaded spindle relative to the spindle nut. The primary lift is caused by moving the spindle nut between the stops. The secondary lift is caused by the linear actuator when the spindle nut makes contact with one of the stops.

According to at least one embodiment, the telescopic linear actuator further comprises a fixed first telescopic part, a movable second telescopic part and a movable third telescopic part, wherein the primary lift is effected by moving the third telescopic part relative to the first and second telescopic parts and the secondary lift is effected by moving the second and third telescopic parts relative to the first telescopic part.

According to at least one embodiment, the motor is non-rotatably connected to the third telescopic part. The second telescopic part is non-rotatably connected to the nut and has an external thread. The first telescopic part has an internal thread which engages in the external thread of the second telescopic part. The secondary lift is effected by twisting the second telescopic part relative to the first telescopic part.

According to at least one embodiment, a thread of the threaded spindle has a higher efficiency factor than the internal thread of the first telescopic part.

The efficiency factor of a thread decreases among others with an increasing thread diameter by the function 1/x and with decreasing thread pitch by a linear function. The efficiency factor directly affects the required drive torque. The second telescopic part, whose external thread engages with the internal thread of the first telescopic part, stands still during rotation of the threaded spindle due to the lower efficiency factor until one of the two stops of the threaded spindle abuts the spindle nut.

According to at least one embodiment, the difference between the efficiency factor of the thread of the threaded spindle and the efficiency factor of the internal thread is selected such that a moving of the secondary lift during a moving of the primary lift is prevented. This deliberately chosen difference between the two efficiency factors ensures that the threaded spindle is moved in the spindle nut until it abuts one of the stops to move the primary lift, and only afterwards, the internal thread is moved relative to the external thread to move the secondary lift. In this way, if, for example, a linear actuator of this type is installed in each of the table legs of a table, it is avoided that different extension positions occur between different table legs.

According to at least one embodiment, the telescopic linear actuator further comprises a fixed first telescopic part and a movable second telescopic part, wherein the primary lift is effected by moving the second telescopic part and the linear drive relative to the first telescopic part and the secondary lift is effected by moving the second telescopic part relative to the linear drive and the first telescopic part.

According to at least one embodiment, the linear drive further comprises a planetary gear. The motor drives a sun gear of the planetary gear. The threaded spindle is non-rotatably connected to a planet carrier of the planetary gear. The linear drive is movably arranged in the second telescopic part. The second telescopic part has an internal thread and a ring gear of the planetary gear has an external thread, in which the internal thread engages. The spindle nut is non-rotatably connected to the first telescopic part and the secondary lift is effected by twisting the ring gear relative to the second telescopic part.

According to at least one embodiment, a thread of the threaded spindle has a higher efficiency factor than the internal thread of the second telescopic part.

In this case, the ring gear remains at rest in the internal thread due to the lower efficiency factor until the threaded spindle abuts the spindle nut with one of the stops.

According to at least one embodiment, the motor has an overload capability. The difference between the efficiency factors of the thread of the threaded spindle and the internal thread means that a higher torque must be applied for the secondary lift. The use of an overload-capable motor is advantageous, since the adjustment of the primary lift, which is frequently used, can be carried out at an optimum motor efficiency. Adjustment of the secondary lift occurs relatively rarely, so that in this case the overload-capable motor can be operated at overload. In the event of an overload, the motor efficiency drops, so that an overload of a power supply used for operation may occur, for example, if a power supply is used for several linear actuators in different legs of a height-adjustable table. In this case, the secondary lift of the various linear actuators can be adjusted stepwise by turns. For example, it is possible to adjust the secondary lift of two linear actuators of a left and a right table leg by turns, each by 1 millimeter, until the desired height of the secondary lift is reached.

According to at least one embodiment, a height-adjustable table includes such a telescopic linear actuator.

The telescopic linear actuator, which can move the primary lift and the secondary lift sequentially, whereby the primary lift is moved independently of the secondary lift, is driven by only one linear drive. The movement mechanisms for adjusting the primary lift and the secondary lift are located in a common actuator housing. Alternatively, the primary lift and secondary lift can also be moved in the height-adjustable table by two independent telescopic linear actuators driven by a common motor. In another alternative embodiment, for example, the primary lift is moved by a telescopic linear actuator and the secondary lift is set by manually adjusting the table height. This can be done, for example, by using a hand crank or a two-stage locking device where a user of the table adjusts the secondary lift by locking the table top at a raised or lowered height.

Other advantageous embodiments are described in the attached claims and in the following description of examples using the attached figures. In the figures, the same reference signs are used for elements with essentially the same function, but these elements do not have to be identical in every detail. Elements with the same reference signs and their properties are sometimes described in detail only when they first appear.

### BRIEF DESCRIPTION OF THE DRAWINGS

FIG. 1 shows a schematic illustration of a table with a telescopic linear actuator,

FIG. 2 shows cross-sections of different configurations of a telescopic linear actuator according to a first embodiment,

FIG. 3 shows cross-sections of different configurations of a telescopic linear actuator according to a second embodiment,

FIG. 4 shows a section of a linear drive in half section, and

FIG. 5 shows a cross-section of a telescopic linear actuator according to a third embodiment.

### DETAILED DESCRIPTION

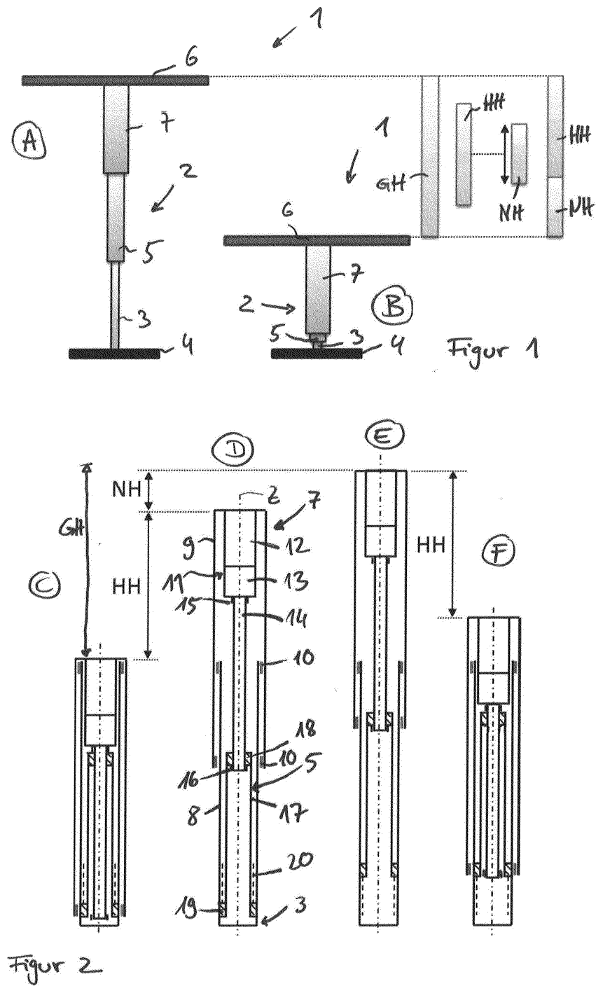

FIG. 1 shows a schematic illustration of a table 1 with a telescopic linear actuator 2 in two configurations A and B. In configuration A, linear actuator 2 is fully extended so that table 1 is at a maximum height. In configuration B, linear actuator 2 is fully retracted so that table 1 is at a minimum height. The difference between the maximum and minimum height of table 1 describes a total lift GH over which linear actuator 2 can be moved.

The linear actuator 2 has a fixed first telescopic part 3 that is connected to a foot element 4 of table 1. A second telescopic part 5 is attached to the first telescopic part 3. The second telescopic part 5 can be moved relative to the first telescopic part 3. A third telescopic part 7 is mounted between a table top 6 of table 1 and the second telescopic part 5. The third telescopic part 7 can be moved relative to the second telescopic part 5. The telescopic linear actuator 2 is arranged between the foot element 4 and the table top 6 in such a way that one end of the first telescopic part 3 facing away from the second telescopic part 5 is attached to the foot element 4 and one end of the third telescopic part 7 facing away from the second telescopic part 5 is attached to a bottom of the table top 6.

The total lift GH, over which the height of table 1 can maximally be adjusted, is divided into a primary lift HH and a secondary lift NH. The primary lift HH and secondary lift NH together make up the total lift GH. In this example, the primary lift HH can be moved independently of the secondary lift NH. The secondary lift NH is moved when the primary lift HH is fully extended or retracted. For example, the primary lift HH can be adjusted by moving the third telescopic element 7 relative to the first and second telescopic elements 3, 5 and the secondary lift NH can be adjusted by moving the second and third telescopic elements 5, 7 relative to the first telescopic element 3. Other combinations for adjustment are of course possible.

This is particularly advantageous if, for example, a sitting height and a standing height are set individually for a user at table 1 and afterwards the table 1 is only moved between the set sitting height and the set standing height. For example, a user in a sitting position can individually adjust table 1 to his or her body height by moving the secondary lift NH. If the user is relatively small, for example, he could extensively lower the secondary lift NH.

In subsequent use of table 1, the user may wish to change between a sitting and a standing position several times a day. Accordingly, he can move the primary lift HH to move the table from a sitting height to a standing height and vice versa. However, this does not involve any adjustment of the secondary lift NH, as the primary lift HH is moved independently of the secondary lift NH. For this application, the primary lift HH is optionally larger than the secondary lift NH. Alternatively, primary lift HH and secondary lift NH can of course be the same, or the ratio can be reversed. As an alternative to the example shown in FIG. 1, it could also be the third telescopic part 7 which is fixed to the foot element 4, the first telescopic part 3 could be connected to the bottom of table top 6 and the second telescopic part 5 could be located between the two telescopic parts 3, 7.

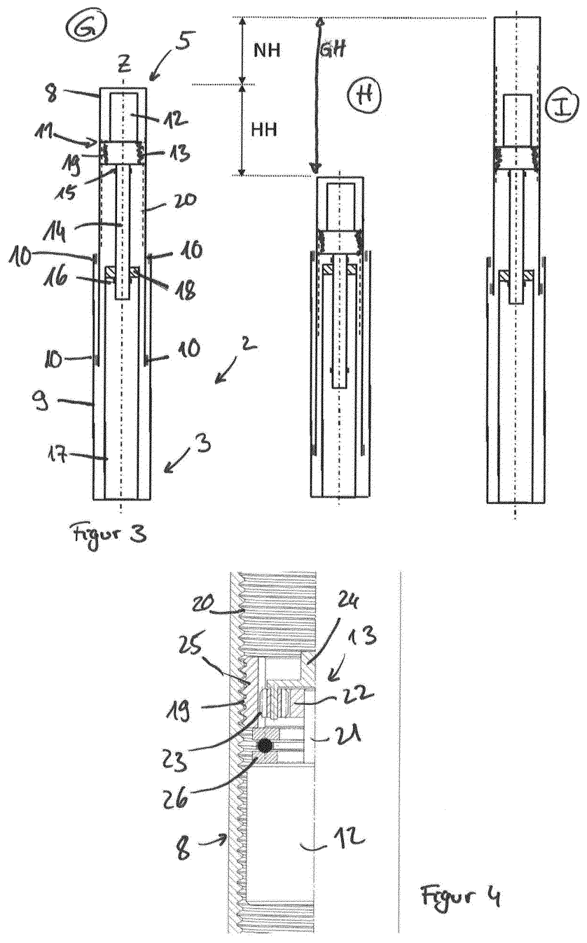

The telescopic linear actuator shown here uses only one linear drive for the adjustment described above. Such linear drives and telescopic linear actuators are described in more detail with reference to FIGS. 2 and 3.

FIG. 2 shows a cross-section of an example of a telescopic linear actuator 2 in four different configurations C, D, E, F. The reference signs shown in configuration D of FIG. 2 equally apply to the remaining configurations C, E, F of FIG. 2.

The telescopic linear actuator 2 shown in FIG. 2 has a first telescopic part 3, a second telescopic part 5 and a third telescopic part 7. The first telescopic part 3 comprises an inner tube 8, which is fixed, for example to a foot part of a table. The third telescopic part 7 has an outer tube 9, which at least partially surrounds the inner tube 8. Inner tube 8 and outer tube 9 are arranged one above the other in cross-section and are guided against each other by guide elements 10. According to this example, the outer tube 9 has guide elements 10 at a lower end on an inside and the inner tube 8 has guide elements 10 at an upper end on an outside. The inner tube 8 and outer tube 9 can have a round or polygonal cross-section. Due to the example described here, only the first and third telescopic parts 3, 7 are visible from an outside in this embodiment.

The telescopic linear actuator 2 has a linear drive 11. The linear drive 11 consists of a motor 12, a downstream gear 13 and a threaded spindle 14. The motor 12 is, for example, an electric motor, the gear 13, for example, a reduction gear, via which the threaded spindle 14 is driven. Alternatively, the threaded spindle 14 can also be driven by a motor 12 in direct drive, without gear 13.

Motor 12 is mounted non-rotatably inside the outer tube 9 at an upper end of the third telescopic part 7. Gear 13 and threaded spindle 14 connect centrally along a central axis Z of the linear actuator 2 below motor 12. Threaded spindle 14 has an upper stop 15 and a lower stop 16. According tot he pictured example, upper stop 15 is located directly below gear 13 on the threaded spindle 14. Lower stop 16 is located at a lower end of the threaded spindle 14.

The second telescopic part 5 has a thrust tube 17. Thrust tube 17 is located inside the inner tube 8. It has a spindle nut 18 at an upper end and an external thread 19 at a lower end. The threaded spindle 14 is rotatably mounted in the spindle nut 18, so that by turning the threaded spindle 14, the threaded spindle 14 can be moved along the central axis Z between the upper stop 15 and the lower stop 16. Inner tube 8 has an internal thread 20 in a lower area which engages in the external thread 19 of thrust tube 17. At least in a lower area of the inner tube 8, where the inner thread 20 is located, the inner tube 8 has an circular inner cross-section. At least the external thread 19 of the thrust tube 17 also has a circular cross-section. Otherwise, thrust tube 17 is designed in such a way that it can be rotated relative to inner tube 8.

Motor 12 drives the threaded spindle 14. By rotating the threaded spindle 14 relative to spindle nut 18, the threaded spindle 14 and thus the entire linear drive 11 and the third telescopic part 7 are set into linear motion along the central axis Z. The movement of the threaded spindle 14 is limited by the upper and lower stops 15, 16. Configuration C shows the linear actuator 2 being fully retracted. In this case, upper stop 15 abuts the spindle nut 18. Configuration D shows the third telescopic part 7 being fully extended. In this case lower stop 16 abuts the spindle nut 18. The threaded spindle 14 can be moved between configurations C and D by rotating in different directions. According to the example shown in FIG. 2, the movement of the third telescopic part 7 describes the primary lift HH of the linear actuator 2.

If in configuration D, threaded spindle 14 is driven further in the direction of rotation with which the third telescopic part 7 has been extended, thrust tube 17 is driven in rotary motion by the butting of the lower stop 16 against the spindle nut 18. Accordingly, the external thread 19 of thrust tube 17 is rotated relative to the internal thread 20 of internal tube 8. The rotation causes a linear movement of thrust tube 17 in the direction of central axis Z. In configuration D, external thread 19 of thrust tube 17 is located at a lower end of the internal thread 20 of the inner tube 8. In this configuration, thrust tube 17 is completely retracted. In configuration E, external thread 19 has been moved to an upper end of internal thread 20. In configuration E, thrust tube 17, i.e. the second telescopic part 5, is fully extended. According to the example shown in FIG. 2, the movement of thrust tube 17 describes the secondary lift NH.

Additionally, in configuration E, since the sense of rotation of threaded spindle 14 has not been reversed regarding configuration D, the third telescopic part 7 stays fully extended as in configuration D. Configuration E thus shows the case where both the primary lift HH and the secondary lift NH are fully extended. Compared to configuration C, in which the linear actuator 2 was fully retracted, the total lift GH was effected in the transition to configuration E.

If, starting from configuration E, the sense of rotation of threaded spindle 14 is reversed, threaded spindle 14 and thus the third telescopic part 7 is retracted again relative to the first and second telescopic parts 3, 5. Retracting the third telescopic part 7 continues until upper stop 15 abuts the spindle nut 18. This configuration is shown in configuration F. The threaded spindle 14 has been completely retracted in configuration F. However, thrust tube 17 is still extended. If, in configuration F, the threaded spindle 14 continues to be rotated in the direction that was used to change from configuration E to configuration F, the threaded spindle 14 sets the thrust tube 17 via the upper stop 15 in motion so that the thrust tube 17 is moved back towards configuration C via its external thread 19 on the internal thread 20 of the internal tube 8.

The sequential movement of the second and third telescopic parts 5, 7 relative to the first telescopic part 3 is caused in this example by the fact that the internal thread 20 of the inner tube 8 is dimensioned so that it has a lower efficiency factor than a thread of the threaded spindle 14. As a result, when the threaded spindle 14 is rotated, initially only the threaded spindle 14 is moved linearly along the central axis Z as long as none of the stops 15, 16 are in contact with the spindle nut 18.

The efficiency factor of a thread has a direct effect on the required drive torque. The relative rotational movement of the threads with the higher efficiency factor (spindle nut 18/threaded spindle 14) is locked when one of the stops 15, 16 makes contact with the spindle nut 18. A rotational movement of the threads with the lower efficiency factor (internal thread 20/external thread 18) is then initiated. Among other things, the efficiency factor of a thread decreases by a 1/x function with an increasing thread diameter and the efficiency factor of a thread further decreases by a linear function with a decreasing thread pitch.

Due to the design of linear actuator 2, the internal thread 20 has a larger diameter than the spindle nut 18. This causes at least partially the difference in efficiency factors described above. In addition, the efficiency factor can be lowered by reducing the thread pitch. For example, internal thread 20 can be designed with a smaller thread pitch than the thread of the threaded spindle 14. Additionally, the secondary lift NH may be subject to less stringent requirements. For example, for the secondary lift a slower movement speed (for example, by reducing the thread pitch), a lower maximum thrust force and/or lower sound requirements may be sufficient. The requirements for the primary lift HH may be the opposite. For example, an industry standard or higher movement speed and/or thrust force and/or low travel noise may be used for primary lift HH. This contributes to the advantages in the efficiency factor design.

According tot he example as shown in FIG. 2, the secondary lift NH can be used, for example, to adjust a height of a table to an individually suitable height for a user. This individual height, i.e. the secondary lift NH, can be adjusted if threaded spindle 14 abuts the spindle nut 18 with the upper or lower stop 15, 16. Once the individual height has been set to a suitable height, the primary lift HH can be used to change between a sitting height and a standing height of the table, for example. This is possible because, for example, a small user essentially requires both a low sitting height and a low standing height of the table. For a tall user, for example, a correspondingly higher setup is required. However, the relative difference between a sitting position and a standing position is similar for both users.

The primary lift HH, for example, can be configured to roughly correspond to this difference between individual sitting position and individual standing position. In this way, a user does not have to adjust the individual heights in a sitting position or a standing position every time, but can generally move the full primary lift HH to change between both positions.

According to this example, the linear actuator 2 is referenced at the minimum position (in configuration C) during initial operation. An electronic system used to control the linear actuator 2 thus knows the zero position (linear actuator 2 completely retracted) and, via corresponding position sensors on motor 12, knows by how much the linear actuator 2 is moved up or down. The electronic system therefore also knows when the stops 15, 16 are reached. According to one example, based on this information, motor 12 is stopped when one of the stops 15, 16 is reached. Then an additional signal is awaited, for example through pressing a control element again to set the secondary lift NH in motion. In this way, a jerky transition is avoided, which could occur when the primary lift HH and the secondary lift NH are moved without interruption due to the different efficiency factors. Alternatively or in addition, motor 12 can be stopped if a significant increase in torque to be applied is detected, corresponding to the difference in efficiency factor between the primary lift HH and the secondary lift NH.

According to an alternative example, not shown here, a movement of the secondary lift NH does not move the outer tube 9, but the upper end of the linear drive 11 is moved out of the outer tube 9. The outer tube 9 is open at the top and is attached to a table frame, which is arranged parallel to the table top 6 below the table top 6. Accordingly, when used in a height-adjustable table system, the secondary lift NH ist he lifting of the table top 6 above the table frame. A limiting factor for the lifting height of a linear actuator 2, is the minimum distance of the guide elements 10 regarding the direction of the drive axis Z, which is necessary to ensure sufficient transverse rigidity between the outer tube 9 and the inner tube 8. In the alternative described herein, the lifting height can be increased while maintaining the same minimum distance between the guide elements 10.

FIG. 3 shows a cross-section of another example of a telescopic linear actuator 2 in three different configurations G, H, I. The reference signs shown in configuration G of FIG. 3 equally apply to the remaining configurations H, I of FIG. 3.

The telescopic linear actuator 2 as shown in FIG. 3 comprises a first telescopic part 3 and a second telescopic part 5. The first telescopic part 3 comprises an outer tube 9, which is fixedly connected for example to a foot part of a table. The first telescopic part 3 further comprises a thrust tube 17, which is at least partially surrounded by the outer tube 9 and is non-rotationally rotationally connected to it. The second telescopic part 5 in this example comprises an inner tube 8. Inner tube 8 and outer tube 9 are arranged one above the other in cross-section and are guided against each other by guide elements 10. According to this example, the outer tube 9 has guide elements 10 at an inside at an upper end and the inner tube 8 has guide elements 10 at a lower end on an outside. Inner tube 8 and outer tube 9 can have a circular or polygonal cross-section.

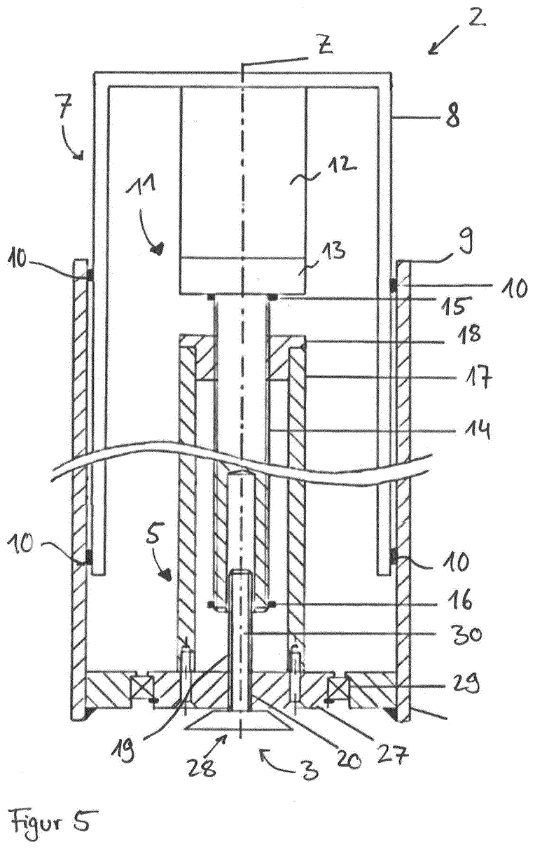

The telescopic linear actuator 2 comprises a linear drive 11. The linear drive 11 consists of a motor 12, a downstream gear 13 and a threaded spindle 14. The motor 12 is, for example, an electric motor that drives the threaded spindle 14 via the gear 13. In this example, the gear 13 is a planetary gear and is described in more detail with reference to FIG. 4. Gear 13 has an external thread 19.

Gear 13 and threaded spindle 14 are connected to motor 12 centrally along a central axis Z of the linear actuator 2 below motor 12. The linear drive 11 is arranged in the centre of the inner tube 8 and can be moved along the centre axis Z. The threaded spindle 14 has an upper stop 15 and a lower stop 16. According to this example, the upper stop 15 is attached to the threaded spindle 14 directly below gear 13. The lower stop 16 is located at a lower end of the threaded spindle 14.

Thrust tube 17 has a spindle nut 18 at an upper end, which is non-rotatably connected to the thrust tube 17. Threaded spindle 14 is rotatably held in the spindle nut 18, so that by turning the threaded spindle 14, the threaded spindle 14 can be moved along the central axis Z between the upper stop 15 and the lower stop 16.

Inner tube 8 has an internal thread 20, in which the external thread 19 of gear 13 engages. Internal thread 20 extends over approximately half of the inner tube 8, but the internal thread 20 can of course also be differently designed. At least in the area of the internal thread 20, the inner tube 8 has a circular inner cross-section.

Motor 12 drives the threaded spindle 14. By turning the threaded spindle 14 relative to the spindle nut 18, the threaded spindle 14 and thus the entire linear drive 11 is set into linear motion along the central axis Z. Since the internal thread 20 has a lower efficiency than the spindle nut 18, the inner tube 8 does not initially move relative to the linear drive 11, but moves together with the linear drive relative to the first telescopic part 3.

The movement of the threaded spindle 14 is limited by the upper and lower stops 15, 16. As shown in configuration H, the linear actuator 2 is fully retracted. In this case, the upper stop 15 abuts the spindle nut 18 and the linear drive 11 has moved completely to an upper end of the internal thread 20. Configuration G shows the case where the threaded spindle 14 has been moved until the lower stop 16 abuts the spindle nut 18. Different senses of rotation of the threaded spindle 14 allow moving between configurations G and H. In the example as shown in FIG. 3, the movement of the linear actuator 11 together with the inner tube 8 describes the primary lift HH of the linear actuator 2.

If, in configuration G, motor 12 continues to exert a force onto gear 13, external thread 19 of gear 13 is rotated relative to the inner tube 8 when the lower stop 16 abuts the spindle nut 18 and therefore locks the threaded spindle 14. This is described in more detail with reference to FIG. 4. This rotation causes the inner tube 8 to move linearly in the direction of the central axis Z relative to the linear actuator 11 and the outer tube 9. In configuration G, the outer thread 19 is at an upper end of the inner thread 20. According to configuration I, the outer thread 19 has been moved to a lower end of the inner thread 20. As shown in configuration I, the second telescopic part 5 is then fully extended. In the example as shown in FIG. 3, the movement of the inner tube 8 relative to the linear drive 11 describes the secondary lift NH.

Additionally, in configuration I, since the sense of rotation of the threaded spindle 14 has not been reversed compared to configuration G, the linear drive 11 is fully extended as in configuration G. Configuration I thus indicates the case when both the primary lift HH and the secondary lift NH are fully extended. Compared to configuration H, in which the linear actuator 2 was fully retracted, in the transition to configuration I, the total lift GH was effected.

If, starting from configuration I, the sense of rotation of the threaded spindle 14 is reversed, threaded spindle 14 and thus linear drive 11 are retracted again relative to the first telescopic part 3. Meanwhile, inner tube 8 remains at rest relative to linear drive 11. The retraction of the linear drive 11 continues until upper stop 15 abuts spindle nut 18. This configuration is not shown in FIG. 3. Threaded spindle 14 would then be fully retracted again. However, the linear actuator would stay at the lower end of the internal thread 20. If the threaded spindle 14 is then operated further in this sense of rotation, the threaded spindle 14 locks at the upper stop 15, so that the inner tube 8 is moved back to configuration H via its internal thread 20 along the external thread 19 of gear 13.

The sequential movement of the primary lift HH and the secondary lift NH is possible in this example because internal thread 20 of inner tube 8 is dimensioned so that it has a lower efficiency factor than a thread of the threaded spindle 14. As a result, when the threaded spindle 14 is rotated, initially only the threaded spindle 14 is moved linearly along the central axis Z as long as none of stops 15, 16 are in contact with the spindle nut 18. The efficiency of a thread has a direct effect on the required drive torque. Only when one of stops 15, 16 abuts spindle nut 18 does the relative rotational movement of the threads with the higher efficiency factor (spindle nut 18/threaded spindle 14) block and a rotational movement of the threads with the lower efficiency factor (internal thread 20/external thread 18) is initiated. Among other things, the efficiency factor of a thread decreases by a 1/x function as the thread diameter increases and the efficiency factor of a thread decreases by a linear function as the thread pitch decreases.

Due to the design of the linear actuator 2, internal thread 20 has a larger diameter than spindle nut 18. This causes at least partially the difference in efficiency factors described above. In addition, the efficiency can be lowered by reducing the thread pitch. For example, the internal thread 20 can be designed with a smaller thread pitch than the thread of the threaded spindle 14. Additionally, the secondary lift NH may be subject to less stringent requirements. For example, for the secondary lift a slower movement speed (for example, by reducing the thread pitch), a lower maximum thrust force and/or lower sound requirements may be sufficient. The requirements for the primary lift HH may be the opposite. For example, an industry standard or higher movement speed and/or thrust force and/or low travel noise may be used for primary lift HH. This contributes to the advantages in the efficiency factor design.

The sequential adjustment of the secondary lift NH and the primary lift HH, for example to adjust a height of a table, can be used, for example, in the same way as in the example described in FIG. 2.

FIG. 4 shows a section of a linear drive 11 in half section. Linear drive 11 shown in FIG. 4 is particularly suitable for use in a linear actuator as shown in FIG. 3. The linear drive 11 as shown in FIG. 4 has a motor 12 and a motor shaft 21. Motor shaft 21 drives a gear 13, in this case a planetary gear. A sun gear 22 is attached to motor shaft 21. Sun gear 22 engages in gear teeth of planet wheels 23, one of which can be seen in FIG. 4. The planet wheels 23 are attached to a planet carrier 24. The teeth of planet wheels 23 also engage in teeth of a ring gear 25. Ring gear 25 has an external thread 19, which corresponds to the external thread 19 of gear 13 in FIG. 3, and engages with an internal thread 20 of the inner tube 8. A threaded spindle 14 as in FIG. 3 can be attached to planet carrier 24.

Sun gear 22 is set in rotation by motor 12 via the motor shaft 21. This rotational movement is transmitted to planet wheels 23. If such a gear 13 is used for a linear actuator 2 as shown in FIG. 3, the external thread 19 has a lower efficiency factor than a threaded spindle not shown in FIG. 4, which is attached to planet carrier 24. As a result, planet carrier 24 is rotated by the planet wheels 23 as long as the threaded spindle is not blocked by one of the stops.

However, if the threaded spindle is blocked, the planet carrier 24 is also blocked via the threaded spindle. As a result, the rotation of the planet wheels 23 causes ring gear 25 including the external thread 19 to rotate. In this way, the rotation of the external thread 19 relative to the internal thread 20 of the inner tube 8, as described with regard to FIG. 3, is achieved. The rotation of the ring gear 25 relative to motor 12 is made possible by a thrust bearing 26 located between the motor 12 and ring gear 25.

FIG. 5 shows a telescopic linear actuator 2 according to a third embodiment in cross-section. This linear actuator 2 also can sequentially move a primary lift FIR and a secondary lift NH, which together make up a total lift GH. The telescopic linear actuator 2 according to FIG. 5 has a first telescopic part 3, a second telescopic part 5 and a third telescopic part 7. The first telescopic part 3 comprises a furniture foot 28 with a shaft 30 extending vertically upwards on the furniture foot 28. The second telescopic part 5 has an outer tube 9. In this example, the third telescopic part 7 has an inner tube 8.

Inner tube 8 and outer tube 9 are arranged one above the other in cross-section and are guided against each other by guide elements 10. According to this example, the outer tube 9 has guide elements 10 at an upper end on an inner side and the inner tube 8 has guide elements 10 at a lower end on an outer side. Inner tube 8 and outer tube 9 can have a round or polygonal cross-section.

The telescopic linear actuator 2 comprises a linear drive 11. The linear drive 11 consists of a motor 12, a downstream gear 13 and a threaded spindle 14. The motor 12 is for example an electric motor, such as a brushless DC motor, and the gear 13 is for example a reduction gear that drives the threaded spindle 14. Alternatively, threaded spindle 14 can also be driven by a motor 12 in direct drive, without gear 13.

Motor 12 is mounted non-rotatably inside the inner tube 8 at an upper end of the third telescopic part 7. Gear 13 and threaded spindle 14 connect centrally along a central axis Z of the linear actuator 2 below motor 12. Threaded spindle 14 has an upper stop 15 and a lower stop 16. In this example, the upper stop 15 is located directly below gear 13 on the threaded spindle 14. The lower stop 16 is located at a lower end of the threaded spindle 14.

The second telescopic part 5 further comprises a thrust tube 17. Thrust tube 17 is located inside the inner tube 8. It has a spindle nut 18 at an upper end. At a lower end of thrust tube 17, a rotatable disc 27 is fixedly mounted to thrust tube 17. At a lower end of the outer tube 9 the rotatable disc 27 is rotatably mounted in a bearing 29. The rotatable disc 27 has a central internal thread 20 which engages in an external thread 19 of shaft 30 of furniture foot 28. The furniture foot 28 is arranged centered at a lower end of the telescopic linear actuator 2, with the shaft 30, on which the external thread 19 is located, projecting upwards in the direction of the central axis Z.

Threaded spindle 14 is rotatably held in spindle nut 18 so that by rotating the threaded spindle 14, the threaded spindle 14 can be moved along the central axis Z between upper stop 15 and lower stop 16. Thrust tube 17 is designed such that it can be rotated relative to inner tube 8.

Motor 12 drives the threaded spindle 14. By turning the threaded spindle 14 relative to the spindle nut 18, the threaded spindle 14 and thus the entire linear drive 11 and the third telescopic part 7 are set into linear motion along the central axis Z. The movement of the threaded spindle 14 is limited by the upper and lower stops 15, 16. Different senses of rotation of the threaded spindle 14 allow movement back and forth between the upper stop 15 and the lower stop 16. According to the example as shown in FIG. 5, the movement of the third telescopic part 7 describes the primary lift HH of linear actuator 2.

If, in case the threaded spindle 14 is fully extended, i.e. the lower stop 16 abuts spindle nut 18, the threaded spindle 14 is driven further in the sense of rotation by which the third telescopic part 7 has been extended, the lower stop 16 catches thrust tube 17 and sets it in the rotary motion. As a result, thrust tube 17 is turned together with the rotatable disc 27. Bearing 29 prevents the outer tube 9 from rotating.

The internal thread 20 of rotatable disc 27 is moved relative to the external thread 19 of furniture foot 28. This rotation a linear movement of thrust tube 17 in the direction of the central axis Z. Accordingly, thrust tube 17 is moved upwards along furniture foot 28. The third telescopic part 7 moves with thrust tube 17. The movement of thrust tube 17 relative to furniture foot 28 describes the movement of the secondary lift NH in the example as shown in FIG. 5.

When moving the secondary lift NH, outer tube 9 is set in linear motion via bearing 29, i.e. thrust tube 17 and outer tube 9 are moved together in this case. A co-rotation of the outer tube 9 during the adjustment of the secondary lift NH, e.g. triggered by static friction on the rotatable disc 27, is prevented, for example, by a shape of the outer tube 9 and the inner tube 8. For example, if outer tube 9 and inner tube 8 have rectangular cross-sections, the outer tube 9 is prevented from rotating together with the rotatable disc 27. For example, if outer tube 9 and inner tube 8 have circular cross-sections, co-rotation is prevented, for example, by rails on the outer tube 9 and/or the inner tube 8 in which the guide elements 10 are guided along the central axis Z. These rails prevent the guide elements 10 from moving perpendicular to the central axis Z, thus preventing rotation of the outer tube 9.

Primary lift HH and secondary lift NH are fully extended when the threaded spindle 14 is stopped through the lower stop 16 abutting the spindle nut 18 and the rotatable disc 27 having reached an upper end of external thread 19 of furniture foot 28.

If the sense of rotation of threaded spindle 14 is then reversed, the threaded spindle 14 and thus the inner tube 8 is retracted again relative to outer tube 9 and furniture foot 28. The threaded spindle 14 is retracted until the upper stop 15 abuts the spindle nut 18. If the sense of rotation of threaded spindle 14 is maintained after the upper stop 15 abutted the spindle nut 18, the threaded spindle 14 catches the thrust tube 17 in its rotational movement via the upper stop 15 so that the thrust tube 17 and the rotatable disc 27 are retracted again via the internal thread 20 along the external thread 19 of furniture foot 28.

External thread 19 is designed such that it has a lower efficiency factor than a thread of the threaded spindle 14. As described above, the efficiency factor directly effects the required drive torque. Therefore, while turning the threaded spindle 14, rotatable disc 27 and furniture foot 28 are at a standstill relative to each other until one of the two stops 15, 16 is reached. Since, in this configuration, the diameter of the external thread 19 is smaller than the diameter of the thread of the threaded spindle 14, the difference in efficiency factor is set in this case, for example, via the thread pitch.

In order to achieve an improved telescope effect, the lower end of threaded spindle 14 in this example is designed as a hollow spindle with a central hole. When the linear actuator 2 is completely retracted, shaft 30 of furniture foot 28 is counterbored inside the hollow spindle.

According to this example, the linear actuator 2 is referenced at the lowest position (linear actuator 2 completely retracted) during an initial start of operation. An electronic system, used to control linear actuator 2, thus knows the zero position (linear actuator 2 completely retracted) and, via suitable position sensors of motor 12, knows by how much the linear actuator 2 is moved up or down. This way, the electronic system also knows when the stops 15, 16 are reached. According to one example, based on this information, motor 12 is stopped when one of the stops 15, 16 is reached. Then, an additional signal is awaited, for example by a signal caused by pressing a control element again to set the secondary lift NH in motion. Accordingly, a jerky transition is avoided, which could occur if the primary lift HH and the secondary lift NH were moved without interruption due to their different efficiency factors. Alternatively or in addition, motor 12 can be stopped if a significant increase in the torque to be applied, which corresponds to the difference in efficiency factors between the primary lift HH and the secondary lift NH, is detected.

Features that are shown here regarding a particular examples can of course be combined in a suitable manner.

1. A telescopic linear actuator, comprising a linear drive, wherein the linear drive is arranged to move the linear actuator over a total lift, the total lift being composed of a primary lift and a secondary lift, and wherein the linear actuator is arranged to move the primary lift and the secondary lift sequentially.

2. The telescopic linear actuator according to claim 1, wherein the primary lift and the secondary lift have different lifting heights.

3. The telescopic linear actuator according to claim 1, comprising a first movement mechanism and a second movement mechanism, wherein the linear drive drives the first movement mechanism during a movement of the primary lift and the linear drive drives the second movement mechanism during a movement of the secondary lift.

4. The telescopic linear actuator according to claim 3, wherein the first movement mechanism comprises a first thread connection and the second movement mechanism comprises a second thread connection, wherein the first thread connection has a greater efficiency factor than the second thread connection.

5. The telescopic linear actuator according to claim 1, wherein
the linear drive comprises a motor, and a threaded spindle driven by the motor,
the linear actuator comprises a spindle nut,
the threaded spindle has two stops spaced apart along a central axis of the threaded spindle,
the threaded spindle is rotatably mounted in the spindle nut,
the linear drive is arranged to move the threaded spindle relative to the spindle nut between the stops,
the primary lift is caused by moving the spindle nut between the stops and
the secondary lift is caused by the linear actuator when the spindle nut abuts one of the stops.

6. The telescopic linear actuator according to claim 5, further comprising a fixed first telescopic part, a movable second telescopic part and a movable third telescopic part, wherein the primary lift is caused by moving the third telescopic part relative to the first and second telescopic parts and the secondary lift is caused by moving the second and third telescopic parts relative to the first telescopic part.

7. The telescopic linear actuator according to claim 6, wherein the motor is connected to the third telescopic part in a rotationally fixed manner, the second telescopic part is connected to the spindle nut in a rotationally fixed manner, the second telescopic part has an external thread, the first telescopic part has an internal thread which engages in the external thread of the second telescopic part and the secondary lift is caused by rotating the second telescopic party relative to the first telescopic part.

8. The telescopic linear actuator according to claim 7, wherein a thread of the threaded spindle has a higher efficiency factor than the internal thread of the first telescopic part.

9. The telescopic linear actuator according to claim 8, wherein the difference between the efficiency factor of the thread of the threaded spindle and the efficiency factor of the internal thread is defined such that a movement of the secondary lift during a movement of the primary lift is prevented.

10. The telescopic linear actuator according to claim 6, wherein the motor is connected to the third telescopic part in a rotationally fixed manner, the second telescopic part is connected to the spindle nut in a rotationally fixed manner, the second telescopic part comprises a rotatable disk that is rotatably mounted at a lower end of the second telescopic part the rotatable disk has an internal thread, the first telescopic part comprises a furniture foot with a shaft projecting perpendicularly along the centre axis, an external thread is arranged on the shaft which engages in the internal thread of the rotatable disk, and the secondary lift is caused by rotating the second telescopic part relative to the first telescopic part.

11. The telescopic linear actuator according to claim 5, further comprising a fixed first telescopic part and a movable second telescopic part, wherein the primary lift is caused by moving the second telescopic part and the linear drive relative to the first telescopic part and the secondary lift is caused by moving the second telescopic part relative to the linear drive and the first telescopic part.

12. The telescopic linear actuator according to claim 5, wherein the motor directly drives the threaded spindle, in particular without a gear.

13. The telescopic linear actuator according to claim 5, wherein the motor is a brushless DC motor.

14. The telescopic linear actuator according to claim 11, wherein the linear drive further comprises a planetary gear, the motor drives a sun gear of the planetary gear, the threaded spindle is non-rotatably connected to a planet carrier of the planetary gear, the linear drive is movably arranged in the second telescopic part the second telescopic part has an internal thread, a ring gear of the planetary gear has an external thread in which the internal thread engages, the spindle nut is connected to the first telescopic part in a rotationally fixed manner and the secondary lift is caused by rotating the ring gear relative to the second telescopic part.

15. The telescopic linear actuator according to claim 14, wherein a thread of the threaded spindle has a higher efficiency factor than the internal thread of the second telescopic part.

16. The telescopic linear actuator according to claim 15, wherein the difference between the efficiency factor of the thread of the threaded spindle and the efficiency factor of the internal thread is selected such that a movement of the secondary lift during a movement of the primary lift is prevented.

17. The telescopic linear actuator according to claim 5, wherein the motor is capable of overload.

18. A height-adjustable table having at least one linear actuator according to claim 1.
